(19) United States
(12) Patent Application Publication
(10) Pub. No.: US 2022/0299354 A1
(43) Pub. Date: Sep. 22, 2022

(54) DEVICE, SYSTEM AND METHOD FOR DETERMINING THE FILL LEVEL OF A CONTAINER

(71) Applicant: TANKTASTIC LTD, London (GB)

(72) Inventors: Nicholas CUNNAH, London (GB); Timothy ABBOTT, London (GB); Andrew CULMER, London (GB)

(73) Assignee: TANKTASTIC LTD, London (GB)

(21) Appl. No.: 17/623,681

(22) PCT Filed: Jul. 1, 2020
(86) PCT No.: PCT/GB2020/051577

§ 371 Date: Dec. 29, 2021

(30) Foreign Application Priority Data
Jul. 1, 2019 (GB) 1909432.5

(51) Int. Cl. G01F 23/296; G01F 23/80

(52) U.S. Cl. CPC G01F 23/2966; G01F 23/2968; G01F 23/804

(57) ABSTRACT

A method of configuring a container model is described, the container model defining a relationship, for a particular type of container and/or contents, between characteristics of an acoustic response and an associated fill level. The method comprises the steps of detecting an acoustic response of a plurality of containers to an acoustic stimulus at a plurality of different times, for each container, obtaining a usage start time, determining a likely fill level for each acoustic response using the usage start time, and associating that acoustic response with the determined likely fill level, to form a set of test data, and computing a relationship between characteristics of an acoustic response and an associated fill level using the test data to generate the container model. In this way, the container model can be trained without a requirement for reference level measurements (or with a reduced need for reference level measurements).

### TECHNICAL FIELD

The present invention relates to a device, system and method for determining the fill level of a container, to a container comprising such a device, and to a method, apparatus and system for configuring a model for use in determining the fill level of a container. The container may be a container for containing contents such as a liquefied gas or beer, but the invention is not limited to this. Embodiments of the invention relate to a self-calibrating method for remote level measurement devices for containers such as cylinders and tanks.

### BACKGROUND

The ability to determine how much gas is contained in a gas cylinder is valuable to both the gas cylinder user (who wishes to know how much they have left, and when they are likely to run out) and the gas cylinder supplier (who wishes to know whether their customers have run out and need replacement cylinders, and preferably would like to predict when their customers will need replacement cylinders so they can streamline their delivery process). Similar principles apply to the beer delivery industry, and many others.

The gas and beer delivery industries have been trying, so far unsuccessfully, to produce a solution that enables a device to be attached to the outside of an existing gas cylinder or beer barrel that will provide a measure of the fill level within the cylinder or barrel in a digital fashion, enabling, with appropriate data connectivity, the level information to be monitored remotely.

Various non-invasive solutions have been considered, and in some cases attempted. Various possible techniques are described in EP0831308, U.S. Pat. No. 6,247,361, WO2009118542, EP2668484, EP2765399, EP2954317, US20140366619 and US20170082477. Some of these use time of flight as the basis for determination but most use frequency domain analysis. The frequency domain techniques utilise an individual ‘peak’ or resonant frequency as the basis for determination, which result in low accuracy, poor robustness to environmental and other factors (such as background noise and the size and shape of the container), and a poor ability to cope with a wide range of contents, for example those held in gaseous form rather than liquid under pressure.

Various possible solutions involving the use of machine learning have been considered, and in some cases attempted. Some techniques are described in CH683208 and US2018044159A1. These require the training of a model to relate a given acoustic response to a specific fill level which is determined from an accurate reference level measurement device. The volume of data required to train a model with the required robustness for industrial deployment makes the requirement for an accurate reference level measurement device impractical.

Any solution should preferably be a connected solution to benefit the gas cylinder supplier. Any device package, as part of a solution, should be capable of being retrofitted to the existing gas cylinder fleet and for safety, should be non-invasive.

The present invention is intended to address at least some of the limitations of the prior art, and to provide a solution in which the fill level of delivered containers (that is, containers which are with, and potentially in use by, customers) can be determined.

### SUMMARY OF THE INVENTION

It will be appreciated that, by fill level, this refers to an amount (generally mass) of contents. The actual surface level (height) of the liquid within the container may vary with temperature for a particular mass of contents. Accordingly, for a particular container orientation (e.g. upright), the surface level of the contents may both rise and fall without there being a change in the amount of contents, and thus the fill level. It will be appreciated that the fill level (mass) is the quantity which embodiments of the present invention seek to track.

Various aspects and features of the present invention are defined in the claims.

According to one aspect, there is provided a method of configuring a container model, the container model defining a relationship, for a particular type of container and/or contents, between characteristics of an acoustic response and an associated fill level, the method comprising the steps of:
detecting an acoustic response of a plurality of containers to an acoustic stimulus at a plurality of different times, for each container, obtaining a usage profile with respect to time, and associating the acoustic responses for that container with the usage profile, to form a set of test data; and
computing a relationship between characteristics of an acoustic response and an associated fill level using the test data to generate the container model.

The step of obtaining a usage profile may comprise obtaining a usage start time for the container. The usage start time may be inferred from location information, or inferred from a change in measured acoustic response from an acoustic response obtained when the container is known to be full. Alternatively, the usage start time may be based on logistics/sales information such as the date (and optionally time) at which the container was delivered or sold.

The usage profile for a particular container may represent a likely fill level with respect to time, and the step of associating the acoustic responses with the usage profile for that container may then comprise determining a likely fill level for each acoustic response based on a time at which that acoustic response was obtained and the usage profile, and associating that acoustic response with the determined likely fill level for that acoustic response.

The method may further comprise obtaining a usage end time and determining the likely fill level for each acoustic response using the usage start time and the usage end time. The usage end time may be inferred from location information, or may be inferred by determining a final fill level before refilling the container, and identifying from the obtained acoustic responses a time at which that fill level was reached.

The method may comprise recording the detected acoustic responses as time domain signals, and converting the time domain signals into frequency domain representations, wherein the characteristics of the acoustic response are frequency characteristics. The relationship may be computed by applying a weight and a bias to an amplitude of each frequency of the frequency characteristics of the test data, and varying the weight and/or bias to minimise an error function. The error function may represent differences between a fill level determined by the container model and estimated fill levels included in the test data.

The method may comprise a step of normalising the usage profile and the capture time of the acoustic responses of each container with respect to time to form the test data. The computing step may utilise a machine learning algorithm.

The method may comprise obtaining a usage end fill level for a container, wherein the step of determining the likely fill level for each acoustic response uses the usage end fill level.

The step of determining the likely fill level for each acoustic response may comprise identifying when on a path from full towards empty the acoustic response was obtained, and identifying, based on an assumed shape of the path from full towards empty, a likely fill level at the time of measurement of the acoustic response. The assumed path from full towards empty may be linear, or may be non-linear, and for example dependent on one or more parameters. Example parameters may include one or more of time of day, day of the week, weather, temperature and local events.

The usage start time may be determined from either a time of delivery of the container to a customer, or a time of fill or refill of the container (logistics information). Similarly, the usage end time may be determined from either a time of return of the container to the supplier or a time of refill of the container (logistics information).

The method may further comprise measuring a temperature at a container at the time of detecting the acoustic response, associating the measured temperature with the acoustic response in the test data, and the step of computing may then compute the relationship between characteristics of the acoustic response, temperature, and associated fill level using the test data.

The step of measuring temperature at a container may comprise measuring a temperature of at least part of the exterior surface of the container and measuring a temperature of the environment around the container, and determining that the container is currently in use in the case that the temperature of the surface of the container is different to the ambient temperature by more than a threshold amount.

The step of measuring temperature at a container may comprise measuring a temperature at a plurality of positions on the exterior surface of the container, and determining that the container is currently in use in the case that a temperature gradient greater than a threshold gradient is measured across the plurality of positions.

It will be understood that the container content temperature influences its volume, which in turn influences the surface level within the container. The surface level and/or volume may influence the acoustic response received, for example due to the acoustic stimulus bouncing off the liquid surface at a different position in the container. It is for these reasons that, for certain types of container contents, taking account of temperature may be important.

The method may further comprise determining whether a container is in use at the time of detecting the acoustic response for that container, associating the in use or not in use state with the acoustic response in the test data, and the step of computing may compute the relationship between characteristics of the acoustic response, the in use or not in use state, and associated fill level using the test data. The in use or not in use state for a container may be determined based on the temperature measurements.

According to another aspect, there is provided a method of configuring a container model, the container model defining a relationship, for a particular type of container and/or contents, between characteristics of an acoustic response and an associated fill level, the method comprising:
detecting an acoustic response of a plurality of containers to an acoustic stimulus each at a plurality of different times; and
computing a relationship between characteristics of an acoustic response and an associated fill level for a particular type of container and/or contents using the detected acoustic responses and without using a reference level measurement.

According to another aspect, there is provided a method of determining a fill level of a container, comprising the steps of:
detecting an acoustic response of the container to an acoustic stimulus;
generating an acoustic profile from the detected acoustic response; and
inputting the acoustic profile to a container model to determine a fill level of the container, the container model defining a relationship, for a particular type of container and/or contents, between characteristics of an acoustic response and an associated fill level; and
using the detected acoustic responses in a method of configuring the container model according to any preceding claim.

According to another aspect, there is provided a system for configuring a container model, the container model defining a relationship, for a particular type of container and/or contents, between characteristics of an acoustic response and an associated fill level, the system comprising:
a plurality of acoustic transducer devices, each operable to detect an acoustic response of a respective one of a plurality of containers to an acoustic stimulus at a plurality of different times;
a configurator, operable to obtain a usage profile with respect to time for each container, and to associate the acoustic responses for each container with the usage profile for that container, to form a set of test data; wherein
the configurator is operable to compute a relationship between characteristics of an acoustic response and an associated fill level using the test data to generate the container model.

According to another aspect, there is provided a system for configuring a container model, the container model defining a relationship, for a particular type of container and/or contents, between characteristics of an acoustic response and an associated fill level, the system comprising:
a plurality of acoustic transducer devices, each operable to detect an acoustic response of a respective one of a plurality of containers to an acoustic stimulus each at a plurality of different times; and
a configurator, operable to compute a relationship between characteristics of an acoustic response and an associated fill level for a particular type of container and/or contents using the detected acoustic responses and without using a reference level measurement.

According to another aspect, there is provided a system for determining a fill level of a container, comprising:
a plurality of acoustic transducer devices, each operable to detect an acoustic response of a respective container to an acoustic stimulus, and operable to generate an acoustic profile from the detected acoustic response; and
a fill level determiner for inputting the acoustic profile to a container model to determine a fill level of the container, the container model defining a relationship, for a particular type of container and/or contents, between characteristics of an acoustic response and an associated fill level; and
a model configurator for using the detected acoustic responses in a method of configuring the container model.

In this way, a method for the training of a computer software model for a stimulus driven fill level measurement system for a container, such as a tank or cylinder, is provided. In summary, a container is agitated and the corresponding frequency response is obtained. The analysis of the resulting response is combined with responses corresponding to different, but unknown, levels within a given container. The method only requires knowledge of the points in time when the container is full. The method determines other (non-full) fill levels of the container by obtaining response data for a number of containers while deployed and while the contents of the container are being consumed.

The method is able to provide a determination of the fill level of contents within a cylinder or tank without having any contact or direct visibility of the contents itself. The method utilises a device, containing a stimulating component and a receiving component. This, for example, could be a speaker and microphone. The device is positioned in proximity to an outside surface of the cylinder or tank. The device can be in proximity to the cylinder or tank in any way.

In order for the device to be able to determine the fill level of any given cylinder or tank, the system does not require any prior knowledge of the tank or the contents. In a system with a reference level approach to model creation, the system can be considered as a two stage process; configuring the model and use of the model. Without a reference level, the process of model creation is no different to the usage phase.

The key components of the invention are in the design, creation and implementation of a model or multiple models configuration that enables a model to be created without the need for a reference level input. This enables significantly more data to be used to create a model and for the model to be regularly optimised and refined from data obtained during normal use.

The key to obtaining a working solution is access to sufficient response data to build a sufficiently robust model with the necessary accuracy for commercial requirements. The requirement of a reference level means the volume of data required is not practicable to develop a working model. The present technique therefore proposes a machine learning model which is not reliant on a reference level obtained using other techniques (although in some implementations the model may be “primed” using reference level measurements).

According to one technique, there is provided a system for determining a fill level of a container, comprising a first acoustic transducer for detecting an acoustic response of the container to an acoustic stimulus, and generating an acoustic profile from the detected acoustic response, and a processor, for inputting the acoustic profile to a container model to determine a fill level of the container, the container model defining a relationship, for a particular type of container and/or contents, between characteristics of an acoustic response and an associated fill level.

The acoustic profile measured by the first acoustic transducer varies as a function of the fill level of the container. This variation can be determined (for a particular container type), and a container model can represent that variation, and in particular can provide a mapping between fill level and acoustic response. The present technique therefore uses the container model, in combination with the acoustic response (as represented by the acoustic profile), to identify the fill level of the container.

The acoustic profile may represent a range of frequencies, with the relative (or absolute) magnitudes of those frequencies providing a distinctive signature. The first acoustic transducer may be disposed proximate to or in contact with the container. In the case of the first acoustic transducer being directional, it may be directed generally towards a surface of the container. The first acoustic transducer may be a microphone. The system may comprise a second acoustic transducer for generating the acoustic stimulus. The second acoustic transducer may be disposed proximate to or in contact with the container. In the case of the second acoustic transducer being directional, it may be directed generally towards a surface of the container. The second acoustic transducer may be a speaker. In an alternative example, no second acoustic transducer is provided, and the acoustic stimulus is instead provided by environmental noise and/or vibrations.

The system may comprise a transducer device and a processing device, the transducer device comprising the first acoustic transducer and a communications unit, the communications unit being operable to transmit the acoustic profile externally of the transducer device, the acoustic profile subsequently being received at the processing device, the processing device comprising the processor. Multiple transducer devices may be linked to the processing device, enabling the processing device to determine and monitor the fill levels of multiple containers. The processing device may be a server which stores container models for a plurality of different types of container, wherein the transducer device transmits an identifier with the acoustic profile, and wherein the processing device is operable to select the container model to use with the acoustic profile using the identifier. In this case, the processing device may be able to determine and monitor the fill levels of multiple different types of container and/or contents. The identifier may uniquely identify the transducer device, and the processing device may be operable to identify a target device, to which a fill level notification is to be sent, using the identifier. In this way, fill level notifications may be sent to an owner (e.g. a supplier) or user (e.g. a customer) of the container in question. For example, fill level notifications for a plurality of containers associated with a given individual or organisation may be sent to an email address, external monitoring software, or portable electronic device (such as a smartphone) associated with that individual or organisation.

The transducer device may be operable to record the acoustic response as a time domain signal, and convert the time domain signal into a frequency domain representation to form the acoustic profile. The frequency domain acoustic profile is then transmitted. Alternatively, the transducer device may be operable to record the acoustic response as a time domain signal, and transmit the time domain signal as the acoustic profile. In this case, the processing device is operable to convert the time domain acoustic profile into a frequency domain acoustic profile before carrying out frequency domain processing to identify the fill level.

The communications unit may be configured to receive a trigger signal, and be responsive to the trigger signal being received to initiate a fill level measurement. In this way, the transducer device may be remotely triggered. The transducer device may comprise an attachment part for attaching the transducer device to a container such that the first acoustic transducer is in contact with or proximate to a surface of the container.

The container may be a gas container, for example a liquefied gas container. However, the present technique may be applicable to other types of container, such as open containers, closed containers, pressurised containers, containers containing liquid, gas or solids, and so on.

Also provided is a method of determining a fill level of a container, comprising the steps of: detecting an acoustic response of the container to an acoustic stimulus; generating an acoustic profile from the detected acoustic response; and inputting the acoustic profile to a container model to determine a fill level of the container, the container model defining a relationship, for a particular type of container and/or contents, between characteristics of an acoustic response and an associated fill level.

Also provided is a transducer device for determining a fill level of a container, the device comprising a first acoustic transducer for detecting an acoustic response of the container to an acoustic stimulus, and generating an acoustic profile from the detected acoustic response, and a processor, for inputting the acoustic profile to a container model to determine a fill level of the container, the container model defining a relationship between characteristics of an acoustic response and an associated fill level for a particular type of container and/or contents. This type of transducer device carries out local fill-level determination. The transducer device may comprise a display screen or other indicator (such as a gauge or set of LEDs) to indicate the fill level. Optionally, the transducer device may comprise a wireless link, such as Bluetooth, WiFi, or 3G, to transmit the fill level indication externally.

Also provided is a transducer device for determining a fill level of a container, the device comprising a first acoustic transducer for detecting an acoustic response of the container to an acoustic stimulus, and generating an acoustic profile from the detected acoustic response, and a communications device, operable to transmit the acoustic profile externally of the transducer device, to a processing device which is responsive to receipt of the acoustic profile to input the acoustic profile to a container model to determine a fill level of the container, the container model defining a relationship between characteristics of an acoustic response and an associated fill level for a particular type of container and/or contents. This type of transducer device transmits an acoustic profile externally, to be processed on a separate device for fill-level determination. The transducer device may comprise a display screen or other indicator (such as a gauge or set of LEDs) to indicate the fill level. The transducer device may comprise a wireless link, such as Bluetooth, WiFi, or 3G, to transmit the acoustic profile externally for fill level determination.

Also provided is a method of initialising a container model for use in the system, method or transducer device described herein, the method comprising the steps of detecting an acoustic response of the container to an acoustic stimulus at each of a plurality of different fill levels of the container, and associating each acoustic response with its associated fill level to form a set of test data, and computing a relationship between characteristics of an acoustic response and an associated fill level using the test data to generate the container model. It will be appreciated that this initialisation is optional, since the configuration method described herein in able to use “live” containers to configure the model. However, in some cases a model initialised in accordance with this paragraph may be beneficial. In such a case, the initialisation method may further comprise recording the detected acoustic response as a time domain signal, and converting the time domain signal into a frequency domain representation, wherein the characteristics of the acoustic response are frequency characteristics. The relationship may be computed by applying a weight and a bias to an amplitude of each frequency of the frequency characteristics of the test data, and varying the weight and/or bias to minimise an error function representing differences between a fill level determined by the container model and the fill levels included in the test data. The computing step may utilise a machine learning algorithm.

According to another aspect of the present invention, there is provided a container, comprising a transducer device as described above.

The design does not rely on any specific frequency at all but rather pattern relationships across differing fill levels that result from the acoustic profile read by the microphone.

The technology can be applied to local as well as remote monitoring, new as well as existing containers, and liquids and solids as well as gases. There is potentially further opportunity outside of the gas and beer industries, for example, for use in vehicle fuel tanks.

### BRIEF DESCRIPTION OF THE DRAWINGS

Embodiments of the present invention will now be described by way of example only with reference to the accompanying drawings where like parts are provided with corresponding reference numerals and in which:

FIG. 1 schematically illustrates a system for determining the fill level of a container, and for calibrating a container model, according to an embodiment of the invention;

FIG. 2 is a schematic flow diagram illustrating the calibration process carried out by the system of FIG. 1;

FIG. 3 is a schematic flow diagram illustrating the fill level determination process carried out by the apparatus of FIG. 1; and

FIGS. 4A, 4B and 4C schematically illustrate example usage profiles for a container.

### DETAILED DESCRIPTION

A solution to some of the problems of known container fill level determination systems can be obtained by utilising an acoustic stimulation-based approach, in which a cylinder-mounted device agitates/stimulates a gas cylinder and listens to the response of the stimulus. This response is converted from a time domain to a frequency domain. The frequency domain response is sent to, and processed by, a computer software model to determine the fill level associated with this response. This model may be created by the provision of multiple responses and an associated reference level measurement with each response. The reference levels may then be used to adjust the model to determine the correct fill level associated with each response.

However, there are numerous limitations to this approach of model creation. Firstly, there is a need for a reference level measurement for every data point collected. This requires an organised data collection process. If the model was to be used on an individual cylinder in a fixed position in fixed environmental conditions, this would be feasible. However, this approach is not well suited to obtain a model that is robust to overcome challenges such as, but not limited to
variations of cylinders (e.g. dents, paint thickness, manufacturing variations)
sensor variations
environmental conditions (temperature, atmospheric pressure, humidity)
physical location
background noise

In order to overcome the challenges of the many variations outlined above, the significant increase in the volume of data required to create a robust model makes the need for a reference level measurement impractical.

In order to overcome these limitations, embodiments of the present invention propose an alternative method which removes (or in some cases at least reduces) the requirement for the associated reference level and therefore enables responses obtained through normal usage to be used for model creation and refinement.

This has a number of distinct benefits. Firstly, it removes, or at least reduces, the requirement for a specific calibration process using reference level measurements which is time consuming and costly. Secondly, it means data collected in normal usage can be used to build a model with the result that larger quantities of data can be obtained in a shorter time frame, thereby obtaining more robust results. Thirdly, the model can continually be refined and improved as normal usage continues which would, otherwise, not be possible without the reintroduction of a reference level measurement. An example of such a system is described below.

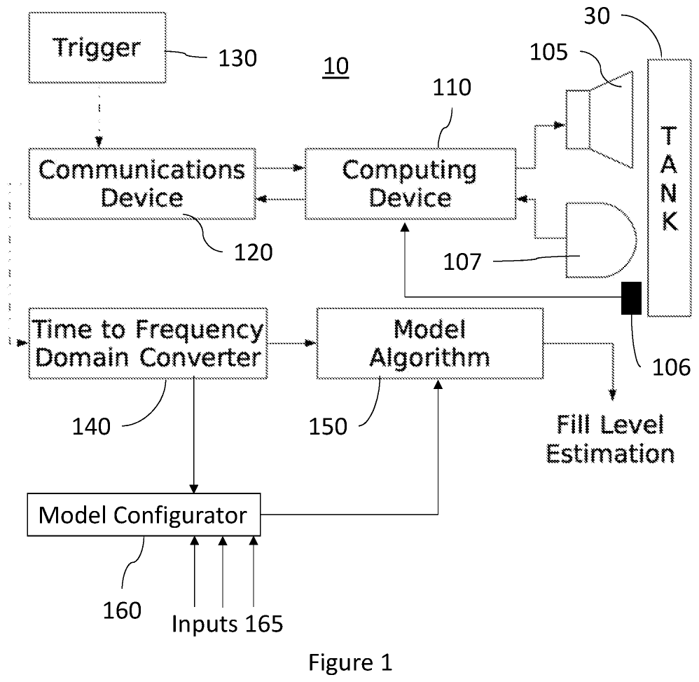

Referring to FIG. 1, a system 10 for the determination of the fill level of a container 30, such as a tank or cylinder, is shown. As will be explained in detail below, the same system is able to both determine the fill level of a container, and also update the container model(s) used to make the determination. The system is intended to determine the amount of content (which may be solid, liquid or gas, or a combination of two or all three of these) in the container, or the proportion of the container which is full. The system utilises a non-invasive approach, which does not require physical access to the inside of the container. Moreover, the approach used does not directly detect the contents of the tank, but measures the impact which the contents (and in particular the amount of contents) has on a property of the container.

The system 1 comprises a speaker 105 and a microphone 107 which are either in contact with or close proximity to an exterior surface of the container 30. The speaker 105 and microphone 107 are both transducers, in the sense that they each convert energy between two different forms (sound, or vibration, and electrical energy). Both the speaker 105 and the microphone 107 are connected to a computing device 110, which comprises a memory and/or data store (not shown) which is capable of storing an electric signal generated by the microphone 107, for example in the form of a file (such as a WAV file). The computing device 110 is also able to control the speaker 105 in emitting, or imparting directly to the container 30, an acoustic stimulus, in the form of a sound, or vibration, across a range of frequencies. The sound or vibration emitted by the speaker 105 may have a constant or varying pitch, and a duration of between a few milliseconds to a few seconds. A chirp signal may be used, ramping up linearly over a frequency range from 200 Hz to 8,000 Hz. However, the system is also able to work effectively using white noise, or shaped white noise (for example pink noise). Other frequency ranges are also viable, and it is anticipated that the frequency range selected for use may vary with container dimensions and contents. If the speaker 105 is not in direct contact with the container 30, it may be positioned and oriented to direct sound onto the exterior of the container 30 to stimulate and agitate the container (and its contents).

When the speaker 105 stimulates the tank in this way, the container will vibrate in a characteristic manner which forms an acoustic response. The acoustic response (that is, the manner in which the container vibrates in response to a given stimulus) has been found to vary as a function of the fill level of the container. For example, the contents of the container may have a damping effect on the acoustic response, which preferentially damps certain frequencies or ranges of frequencies. The fuller the container, the greater the damping effect may be. In any case, the microphone 107 picks up the acoustic response induced in the container from the stimulus produced by the speaker 105. Generally, the agitation of the container and the measurement of the response are carried out simultaneously using two discrete transducers (speaker and microphone). It is possible that an “echo” based approach may be viable, in which the container is first agitated, and then the acoustic stimulus discontinued and the acoustic response (echo) then measured. In this case, the same transducer could be used (in different modes) for both agitating the container and measuring the response. It is also possible to use a single transducer to simultaneously stimulate and measure, whereby the measurement is inferred from the back electro-motive force of a speaker. Where two transducers are provided, the speaker 105 and microphone 107 may be disposed closely together, or spaced apart. The resulting output can be stored or sent directly via the communications device 120, which is connected to the computing device 110, as a time-domain acoustic profile.

The communications device 120 is operable to receive a trigger signal from an external trigger 130, in response to which the computing device uses the speaker 105 and microphone 107 to agitate the container 30 and obtain an acoustic profile. The communications device 120 is also operable to transmit the time domain acoustic profile to a time to frequency domain converter 140, where it is processed to convert it into a frequency domain acoustic profile. A model algorithm 150 is provided which is able to convert the frequency domain acoustic profile into a fill level. The model algorithm 150, and the manner in which it is trained, will be described in detail subsequently. The present invention may be embodied (primarily) in the form of either a local device or a distributed system. In a local device, the speaker 105, microphone 107, computing device 110, communications device 120, trigger 130, time to frequency domain converter 140 and model algorithm 150 may all be provided as a single device. In this case, the communications device 120 may be considered a data bus (or may be dispensed with entirely). In a distributed device, the speaker 105, microphone 107, computing device 110 and communications device 120 may form a transducer device, while the trigger 130, time to frequency domain converter 140 and model algorithm 150 form a processing device, separate from the transducer device. Also provided, separately from the transducer device, is a model configurator 160, which receives inputs 165 from various sources in addition to receiving the acoustic profile. The purpose and function of the model configurator 160 will be described subsequently. In the case of a distributed system, the model algorithm 150 and the model configurator 160 may each be provided at the same server or respective different servers.

It will be appreciated that variations of this are possible. For example, the trigger 130 may be provided separately from the time to frequency domain converter 140 and model algorithm 150 (that is, not part of the processing device). In one implementation, the trigger 130 may be a function of a smartphone app or software program running on a device associated with an individual or organisation to which the monitored container belongs. In this case, a user may use the smartphone app or software program to check on a current fill level of the container. In response, the smartphone app or software program may generate a trigger signal which is communicated (either directly, for example via Bluetooth, or indirectly, for example via WiFi or 3G and an intervening telecommunications network) to the transducer device. The transducer device is then responsive to the received trigger signal to start the fill measurement process.

In another embodiment, the time to frequency domain converter 140 may be provided within the transducer device, and disposed between the computing device 110 and the communications device 120. In this case, the acoustic profile transmitted from the transducer device to the processing device is a frequency domain signal/file rather than a time domain signal/file. Further, part of the model algorithm may be provided at the transducer device and part of it at the processing device, with the result that the acoustic profile transmitted from the transducer device to the processing device may be partially processed. One reason to distribute the model algorithm over the two devices may be to reduce the size of the acoustic profile for transmission (by partially processing it at the transducer device) which enables the part of the model algorithm 150 provided at the processing device to be updated and refined without needing to “download” updates to the transducer device. It will be appreciated that in a practical implementation of this technique, the processing device may be implemented as a central server, which communicates with, and processes the acoustic profiles from, a large number of transducer devices. In this case, the part of the algorithm carried out by the server can be updated when required, without needing to roll out an update to the transducer devices.

Where the processing device is a server, this may store multiple container models for a plurality of different types of container. In this case, the transducer device may transmit an identifier of the type (or instance) of the container along with the acoustic profile so that the server is able to select the correct container model to use with the acoustic profile using the identifier. The identifier may also uniquely identify the transducer device so that the server is able to identify a target device (such as the smartphone indicated above) to which a fill level notification is to be sent.

Generally, the transducer device will operate using a battery power source (not shown). It will be appreciated that the transducer device may spend most of its time in a dormant mode where it consumes a very small amount of power, and may “wake up” periodically or on demand to take measurements. For example, the communications device 120 may continue to operate as a receiver during the dormant mode, and be responsive to a trigger signal to wake up the transducer device to take measurements. Alternatively, if measurements are to be taken periodically, a timer (not shown, but potentially implemented as part of the communications device 120 or computing device 110) may function during the dormant mode, and may trigger the transducer device to wake up when a measurement is due to be taken. The processing device may be implemented on a server, or general purpose computer, and thus powered using mains electricity. In an alternative embodiment, the processing device might be implemented on a portable electronic device such as a smartphone or tablet, in which case the processing device too will be battery powered.

A temperature sensing device 106 (for example a thermometer) is preferably provided at the transducer device. The temperature sensing device 106 may be either a single sensor which measures the temperature of the exterior of the container at a single position (for example the position at which the transducer device is mounted), or a plurality of sensors arranged to measure the temperature at a variety of different positions of the exterior of the container.

A reason for (in some implementations) providing multiple temperature measurements at different positions on the container is that the temperature inside the cylinder, which is what will determine the exact relationship between liquid level versus mass of content may be subject to significant temperature gradients when burning gas rapidly. In particular, the cooling effect can be very significant. By providing multiple temperature measurements at different positions, this can be identified. This information may also be used to determine whether the container is currently in use or not in use—that is, if the container is not in use, no temperature gradient, or only a small temperature gradient (less than a threshold) will be detected, whereas if the container is in use, a temperature gradient greater than a predetermined threshold will be detected. This makes it possible for the container model to be optimised with respect to “in use” and “not in use” states).

In a simpler, cheaper and more practical implementation, the temperature inside the cylinder may be estimated by measuring both the ambient temperature and also the cylinder temperature at the position where the transducer (sensor) device is attached (generally the top of the cylinder). Similarly, if a temperature of the container is less than the ambient temperature by an amount greater than a threshold, the container can be assumed to be “in use”, and otherwise “not in use”, in an analogous manner to determining a temperature gradient.

The temperature sensing device 106 might also comprise an ambient temperature sensor which measures the temperature of the environment within which the container is disposed. In any case, the temperature sensing device 106 generates one or more signals indicating respective temperature measurements, and provides these to the computing device 110. These signals may be packaged up with the acoustic data and communicated to the model algorithm 150 and model configurator 160 along with the acoustic data, time of capture (of acoustic data and temperature data) and any other parameters collected by the device, as discussed elsewhere. The temperature sensing device is provided due to the fact that the acoustic response of a container at a given fill level may vary in dependence on the temperature of the container and/or the ambient temperature in the local environment. This temperature dependence may be accounted for in several ways. For example, the container model may itself be robust enough to map not only an acoustic profile, but also one or more temperature readings temporally associated with that acoustic profile, to a given fill level. Alternatively, a separate algorithm or temperature dependency model (for example a look up table) might be used to compensate for temperature, for example by modifying the acoustic profile before it is input to the container model, or converting a fill level determined by the model into a reported mass of content. It will be appreciated that only certain container types and/or content types may require a temperature dependent model. LPG containers for example may have a relatively high degree of temperature dependence, whereas beverages such as alcohol may result in a lower degree of temperature dependence, such that a temperature sensing device 106 may not be required. Similarly, for applications where a high level of accuracy is not important, then it may not be essential to monitor temperature. For the best results when measuring LPG, it is preferable either to input temperature directly to the model and allow the model learn the temperature relationship, or alternatively use the temperature value in a post-processing step to effectively convert from a liquid level to a reported mass of content.

In order for the device to be able to determine the fill level of any given cylinder or tank, the system requires knowledge of how that given tank and its contents influence the acoustic response obtained when the tank is agitated with a given acoustic stimulus. This is achieved by configuring, or training, the model which is implemented within the system to determine the fill level of any tank or cylinder of that type with those contents. It will be appreciated that by “type”, this may mean the dimensions (size and shape) of the container, the thickness of the walls of the container, whether the container is a closed (sealed) container or an open container, and any other characteristic of the container. A type of container may be a particular model of container of a particular make. For a particular model, the acoustic response to a given acoustic stimulus can be expected to be broadly similar, even if there may be some differences between instances of the same model due to manufacturing variations. Accordingly, by training the model using one instance of a container type, the resulting model should be effective when applied to the acoustic response of any other instance of that container type. Greater resilience to variations in specific instances of container may be achieved by training the model using multiple instances of a given container type. These variations could result from effects such as damage to a container or paint being applied. The nature of the contents of the tank are also relevant, since different contents may influence the acoustic response of a given container in different ways. Here, the nature of the contents may include the phase (liquid, gas, solid or a combination of two or more of these), the chemical composition, the temperature and/or the pressure. The main influence of the contents of the container on the acoustic response may be in terms of density, with denser contents (such as water) potentially having a greater damping effect than lighter contents such as butane (as a liquefied gas) or completely gas phase contents.

The present technique can be considered as a two stage process; configuring the model and applying the model. However, as the process of data collection for both stages is identical, these processes can occur at the same time; data collected to determine the fill level using a current model and that same data used, in conjunction with further data, to build an updated, improved model. It may be considered, as an initial stage, to provide the model with some training data prior to deployment.

Configuration of the Container Model

When a gas cylinder leaves a supplier to be delivered to a customer, the cylinder is registered as full in a database system. The registration of the gas cylinder as full may take place at the time of refilling, at the time of dispatch to a customer, or at any time in between. The database system may be a dedicated database used to implement the present technique, or an existing database operating by the supplier for other purposes. The information may typically be obtained through either existing logistics records and/or from the tracking capability on the device itself. Later, when the gas cylinder is returned to the supplier, the cylinder is registered as less than full in the database. In practice, the vast majority of gas cylinders will be returned empty or close to empty. While the gas cylinder is with a customer, it is assumed that the gas level will decrease over time and never increase. It may of course stay the same for extended periods.

The rate and timing of gas usage for an individual gas cylinder, over time, starting from full is not known. By extension, the individual usage paths of many cylinders are also not known. However, by extending the number of cylinders in the data set to a relatively large number, some assumptions can be made about the collective.

For the purposes of explanation, the method will be simplified by assuming that the gas cylinder usage path always extends from full to empty, and that the time for a gas cylinder to empty is normalised across the data set. This normalisation may be referred to a temporal normalisation, and is predicated on the fact that a given cylinder may go from full to empty over one week through heavy usage, while another cylinder may empty over six months. Normalising the time (from full) to empty (or to a known usage-complete level) comprises ignoring the specific duration in time for any particular cylinder to empty, and the duration in time between acoustic profiles being selected between full and empty for that cylinder, and instead, effectively representing the duration between (acoustic profile) events captured in relation to a cylinder as a percentage/proportion of the time the cylinder is in the field (that is, a proportion of the time period between full and empty), as opposed to an absolute time elapsed in day/hours/minutes.

Assuming a normal distribution of usage for all gas cylinders at all times in the data set, the usage path over time with highest probability may be a linear path from full to empty. This provides a good starting hypothesis for a usage path, however, any usage path could be chosen as a starting hypothesis, such path preferably being chosen to be representative of the average usage profile.

The choice of a linear path is based on a hypothesis regarding the usage of gas across an entire client base of gas cylinder users. It is clear that usage rates will vary dependent on a number of factors such as usage type. For example, home heating will use more gas in the winter than the summer, meanwhile forklift trucks might be used during the day and not at night.

All cylinders are used at varying rates of consumption; some may empty in a matter of days, while others might take months or even more. If normalising the time taken to empty the cylinder, such that a cylinder is considered full at t=0 and the cylinder is empty at t=1, the speed of gas usage has been made independent due to the normalisation with respect to time.

As the rate of normalised use is independent, the central limit theorem states that the usage will closely resemble a normal distribution. This can be graphically represented with the x-axis as normalised time and the y-axis as the fill level. The means of the normal distributions will be reflected by a diagonal line from full at t=0 to empty at t=1.

In order to configure the container model, the system of FIG. 1 comprises a model configurator 160, which receives the acoustic profile generated by the time to frequency domain converter, along with the time of capture of the acoustic profile. It will be appreciated that the model configurator 160 will be a centralised function, generally carried out at a server or other computing device remote from the level measurement device itself, and in communication with a large number of level measurement devices attached to a large number of containers. The model configurator 160 carries out a machine learning process to train the container model used by the model algorithm 150. Notably, no reference level meter need be provided (although the model may in certain embodiments be initialised under controlled conditions using fill levels from a reference level meter), and training is carried out using acoustic profiles captured live in the field from a large number of containers. In order to do this, the model configurator needs to know an estimated fill level and a corresponding acoustic profile for that given fill level estimation, for the type of container (and contents) in relation to which the container model is to be used. The acoustic profile is preferably the same one used to compute the current fill level, and is in any case generated from a signal received by the microphone 107 attached to or proximate the cylinder or tank 30. The signal from the microphone 107 is converted into sound data by the computing device 110 and is subsequently converted by the converter 140 from time domain sound data into a frequency domain output which defines the acoustic profile. If required, further signal processing steps may be carried out on the frequency domain output to form the acoustic profile, such as filtering the signal to remove noise or frequency ranges known not to be useful for the model. Either alternatively, or additionally, signal processing could be carried out on the time domain signal before conversion to the frequency domain.

The acoustic profile is obtained a plurality of times over the usage life (that is, a plurality of times between refills) of the container. The time at which each acoustic profile is obtained is stored in association with the acoustic profile. The acoustic profiles may be transmitted, or stored locally. The same process takes place on a plurality of containers. In particular, each of a plurality of instances of the apparatus independently and concurrently obtains acoustic profiles with respect to time, and provides these (either as they are generated, or in accumulated form once the container has been returned to be refilled, for example) to the model configurator 160. The fill level of each container can be assumed to gradually (or even rapidly) reduce over time, and thus present a plurality of fill levels from and between the extremes of full and empty. The result of this process is a (large) set of acoustic profiles which are associated with respective estimated fill levels (multiple acoustic profiles for each fill level, one set of acoustic profiles from each container). Each acoustic profile may be considered as a set of frequency domain amplitude information (that is, data representing the amplitude of each frequency component). The available frequency domain amplitude information up to the Nyquist frequency or the maximum frequency response of the microphone for every fill level are passed through a multi-layer optimisation model.

For any given gas cylinder at any given point, the difference between the predicted level and the level assumed based upon the above hypothesis can be determined by the following error function, which the optimisation model attempts to minimise for all the estimated fill levels obtained as described above:

Eₒ=(d−Yₒ)²
where Eₒ=Output Error
d=linear hypothesis value
Yₒ=model level value

It should be noted that the both d and Yₒ are matrices of data relating to the output response resulting from the agitation of a gas cylinder. This output response results from converting sound data in the time domain to sound data in the frequency domain up to the Nyquist frequency of the maximum frequency response of the receiving component. The output error data for all the data obtained from multiple cylinders is passed through a multi-node, multi-layer optimisation model to minimise the overall output error. This is achieved by taking the frequency domain information as the input and applying a weight and bias to each frequency and corresponding amplitude value at each node given by:

$$Z = \text{?} \sum \text{?} \qquad ( eq 1 )$$

$$\text{?} \text{indicates text missing or illegible when filed}$$

where Z=nodal output
i=number of frequency data points
w=weight applied to each specific input
x=input amplitude of the specific frequency
b=bias applied to a specific input

The nodal output is then passed via the following sigmoid function:

$$σ ( Z ) = \frac{1}{1 + {e}^{-} Z} \qquad ( eq 2 )$$

This ensures a defined range for the output between 0 and 1 from the varying weights applied. Applying the function given in eq 1 into Z of eq 2 gives the output function:

$$MeasuredFillLevel ( MFL ) = \frac{1}{1 + \text{?} \sum \text{?}} \qquad ( eq 3 )$$

$$\text{?} \text{indicates text missing or illegible when filed}$$

The MeasuredFillLevel (MFL) is the output of the model. An error function relating to the MeasuredFillLevel (MFL) is minimised so that the model level value matches the hypothesis level value with minimal differences. This is achieved through partial differentiation with respect to both the weights and bias and is a linear function of the changes in the weights and bias. A simplified representation of an exemplary error function is defined:

$$Δ MFL \approx {\sum }_{i} \frac{δ MFL}{δ {w}_{i}} Δ {w}_{i} + \frac{δ MFL}{δ b} Δ b$$

The minimisation of the error function leads to the setting of the weights and bias within the multi-layer model depicted above to enable an accurate measured fill level to be achieved.

At this point, the model has been calibrated for the given tank/cylinder/contents type and the result is a configured model which is subsequently implemented to measure any tank of that type and contents. As the data collection method for model generation is implemented in the same way as fill level determination, the model can be regenerated as more usage data is accumulated enabling the model to be continually refined.

The above explanation is intended to indicate the general principles of using machine learning to convert training data (in this case a set of acoustic profiles and associated estimated fill levels) into a model which is substantially optimised to be able to convert further acoustic profiles into fill levels. Training data could represent either frequency or time domain information. Machine learning techniques and algorithms will be well known to persons skilled in the art, and the skilled person would be able to implement the present technique using the above machine learning method, or one of many alternative methods. It should also be understood that a container model could (in principle) be arrived at without relying on machine learning. For example, characteristics of a container and/or its contents could be mathematically modelled and a likely acoustic response inferred.

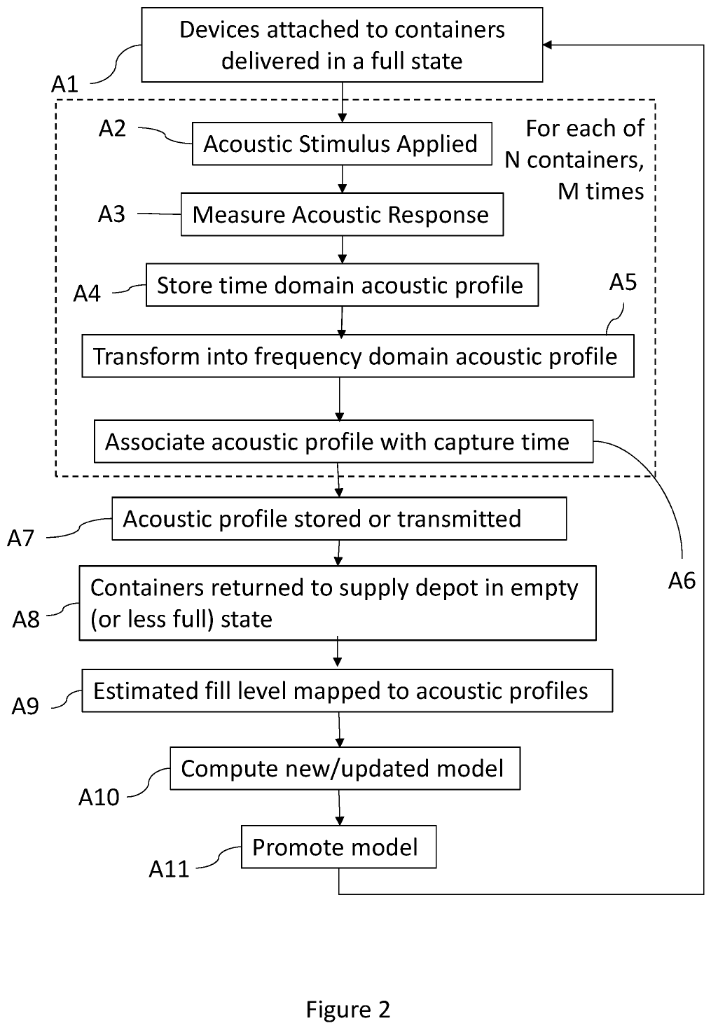

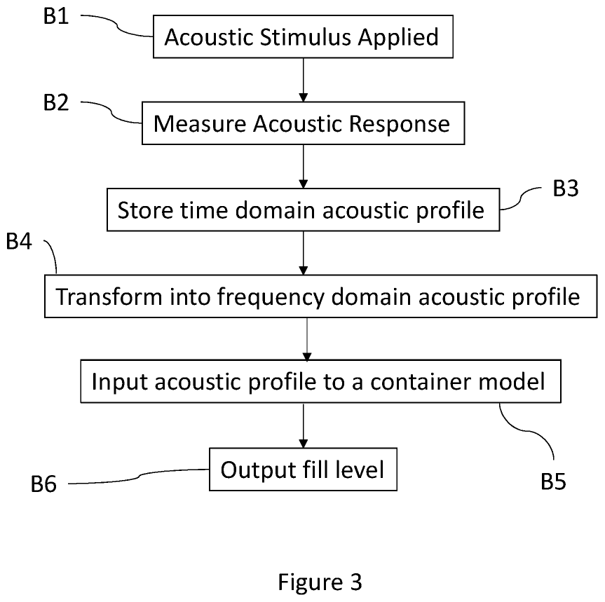

FIGS. 2 and 3 respectively describe the configuration process and the fill level determination process carried out by the system of FIG. 1. For simplicity these are described as separate processes, but in practice (and as explained elsewhere) the two processes are carried out at the same time (in parallel) with some steps being common to both processes. That is, some of the data used for the fill level determination process is utilised in the configuration process without needing to obtain and compute that data again.

A high level explanation of the configuration process is shown in FIG. 2, in which at a step A1 devices 1 to N which are attached to containers are delivered in a full state to customers. At a step A2 an acoustic stimulus is applied, using a speaker, to one of the containers being used to train the algorithm. At a step A3, an acoustic response of the container to the applied stimulus is measured, using a microphone. At the same time, if applicable, a container temperature may also be obtained (by the temperature sensing device). At a step A4, the acoustic response is stored as a time domain acoustic profile. The time domain acoustic profile may then optionally undergo signal processing, for example to filter out noise. At a step A5, the time domain acoustic profile is converted into a frequency domain acoustic profile in accordance with well known techniques. The frequency domain acoustic profile may then optionally undergo signal processing, for example to filter out noise, or frequency components known not to be useful for the present technique. At a step A6, the acoustic profile is associated (correlated) with the time at which it has been obtained (and if applicable, the container temperature at that time), and the acoustic profile and capture time are stored together (and/or transmitted together to the model configurator). The steps A2 to A6 are carried out multiple (M) times (that is, periodically over time, either at predetermined time intervals or on demand using the trigger 130) for each of the plurality N of containers.

The data generated by the steps A2 to A6 constitutes test data. As discussed elsewhere, some or all of the data may also be used to provide users with estimated fill levels for the respective containers based on a current version of the container model. At a step A7, the acoustic profile is stored or transmitted at regular intervals while the container is with customers and in use. At a step A8 the container is returned from the customer to a supply depot, likely empty or close to empty, and almost certainly less than full. At a step A9 an estimated fill level is applied to each new acoustic profile according to an assumed usage function (for example, assuming linear usage over time between first use or supply and return to the depot) of the container in relation to which the acoustic profiles were obtained. At its simplest, this may be a normalised linear function decreasing from full to empty from a start time to an end time, with each acoustic profile being mapped to the usage profile (and in particular a fill level within the usage profile) in dependence on its time of capture, and in particular on its temporal position (as a percentage) between the start time and end time of the usage profile. At a step A10 a new container model is then generated between frequency characteristics of the acoustic response (profiles) (optionally along with container temperature and any other parameters) and associated fill level estimations, using the test data and machine learning, in the manner described above. At a step A11 the new model is promoted to replace the previous model, and is then used to determine fill level estimates from live acoustic profiles. As explained in more detail above, the relationship may be computed by applying a weight and a bias to an amplitude of each frequency of the frequency characteristics (or other characteristics such as container temperature) of the test data, and varying the weight and/or bias to minimise an error function representing differences between a fill level determined by the container model and the fill levels included in the test data. The computing step will be understood to utilise a machine learning algorithm.

Applying the Container Model

The structure and the operation of the device and system for carrying out fill level determination using the container model has been described in detail above with reference to FIG. 1. However, the process is summarised again here, with reference to the trained container model, and with reference to FIG. 3. At a step B1, an acoustic stimulus is applied to the container (by the speaker). At a step B2, an acoustic response to the stimulus is measured (by the microphone). At the same time, if applicable, a container temperature may also be obtained (by the temperature sensing device). At a step B3, the acoustic response is stored as a time domain acoustic profile. The time domain acoustic profile may then optionally undergo signal processing, for example to filter out noise. At a step B4, the time domain acoustic profile is converted into a frequency domain acoustic profile in accordance with well known techniques. The frequency domain acoustic profile may then optionally undergo signal processing, for example to filter out noise, or frequency components known not to be useful for the present technique. It will be appreciated that the steps B1 to B4 are substantially identical to the steps A2 to A5, but are carried out only once (in general, although they could be carried out multiple times and averaged to mitigate the effects of background noise), and are carried out in relation to a container for which the fill level is unknown. At a step B5, the acoustic profile (and if applicable, temperature) is input to the container model obtained using the process shown in FIG. 2. At a step B6, an output of the container model is output as an indication of the fill level of the container.

While expressed as an algorithm in the above description, it will be appreciated that, once calibrated for a particular container and/or contents, the resulting container model could be provided as a look up table, referred to by extracting (preferably) frequency characteristics of the acoustic profile and using them to reference the look up table.

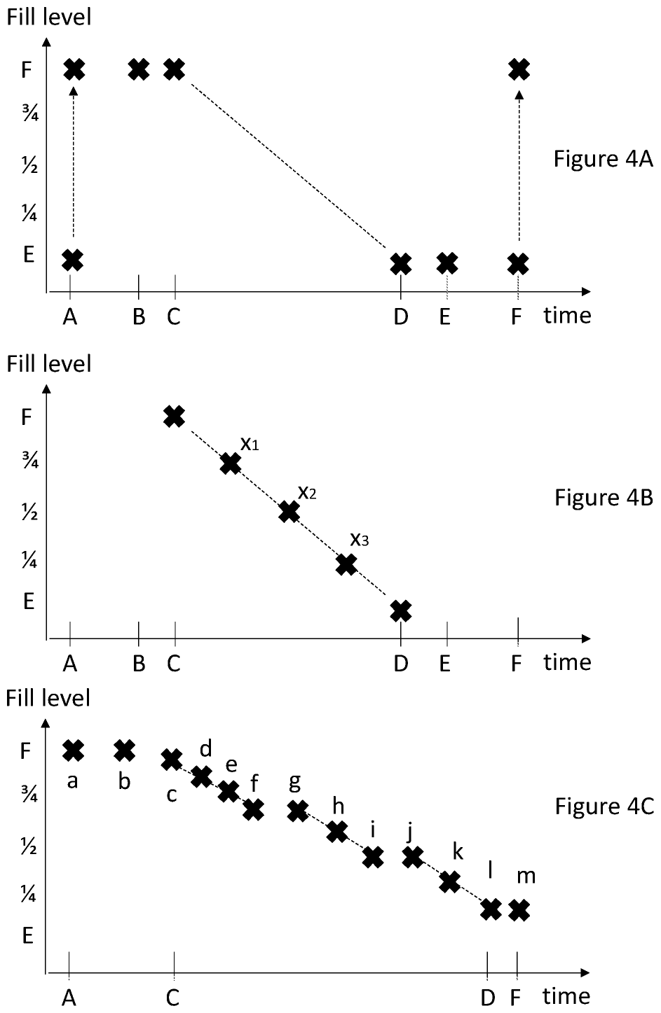

Referring to FIGS. 4A to 4C, a further explanation of the generation of the usage profile is provided. In FIG. 4A, a graph shows fill level of a particular container as a function of time. On the y (vertical) axis, a fill level from empty (E) to full (F) is shown, with ¼, ½ and ¾ full increments intervening. On the x (horizontal) axis, six different events are shown, labelled A to F. At a time A, the container has just been (re)filled. At a time B the container is delivered from a (gas) supplier to a customer. At a time C the container is used for the first time by the customer. After the event A, and at each of events B and C the container is known to be full. At a time D the customer stops using the container. At a time E the container is returned from the customer to a/the supplier. At a time F the container is refilled. At the times D and E the container can be assumed to be empty (or at least to be less than full). At the time F, which can be considered to correspond to time A, the container transitions from empty (or less than full) to full. In FIG. 4A, the fill level of the container for each of these times is denoted by an “X”. A line (from full to empty) can be drawn from the fill level (full) at time C to the fill level (empty) at time D. In some embodiments it is possible to know, or derive, points C and D, which may provide the greatest usage accuracy. In other embodiments only points A and/or B and/or E and/or F may be known, and points C and D may instead be assumed. For example the point C may be assumed to be a fixed period of time following A or B, while the point D may be assumed to be a fixed period of time before E or F. Alternatively, logistics information may be used to infer time C from time B, and/or time D from time E. Alternatively, the usage profile from full to empty may be computed instead from time A or B to time E or F.

Whichever start and end times are used, between these times it may be assumed, in certain implementations, that usage is linear, as per the line shown between C and D in FIG. 4A. As a result, if an acoustic response is obtained at a particular time, an estimated fill level at that particular time can be determined by interpolation between the full state of the container at time C and the empty state of the container at time D, and that estimated fill level can be associated with that acoustic response. This process is then repeated a plurality of times between time C and time D, and the resulting acoustic response and fill level pairs are used as test data to train the container model as discussed herein.

In FIG. 4B, a simple example is shown in which acoustic responses are captured at time C (when the container is assumed to be full), at time D (when the container is assumed to be empty, or to be at a fill level which is less than full (and preferably known—for example measured at the time of refill), and at three times between C and D, specifically at x₁, x₂, x₃. It can be seen that a fill level to be associated with x₁ is %, a fill level to be associated with x₂ is ½, and a fill level to be associated with x₃ is ¼. This association is achieved by, in relation to each obtained acoustic profile, using the time of capture of the acoustic profile within the duration of the usage profile to predict a likely fill level at that time. As discussed elsewhere, by “time” it may be meant the percentage of the way through the usage time (from usage start to usage end) at which the acoustic profile was obtained. Accordingly, the reason that the fill level at x1 is estimated at ¾ is that it was captured ¼ of the way through the usage life of the container, the reason the fill level at x2 is estimated at ½ is that it was captured ½ way through the usage life of the container, and the reason the fill level at x3 is estimated at ¼ is that it was captured ¾ way through the usage life of the container. It will be appreciated that this simple case applies only for a linear usage profile, but that the general principle that any usage profile can be represented over time and/or over a usage period from empty to full enables acoustic profiles captured during a usage period to be associated with estimated fill levels in dependence on their time of capture, or proportion of the way through the usage period.

In practice, a relatively large number of acoustic responses are likely to be obtained between C and D, providing greater volumes of data to support larger quantities of test data for the machine learning applied to generate the container model, as well as to support pre-processing techniques (such as averaging and error detection) which may improve the quality of the test data input to the machine learning algorithm. For example, if a cluster of acoustic profiles are obtained, in relation to a particular container, at around the same time, individual or small numbers of acoustic profiles with characteristics (for example frequency characteristics) which differ substantially from the bulk of the acoustic profiles collected at around the same time may be ignored. Further, acoustic profiles captured at around the same time and in relation to the same container may be averaged, or otherwise processed together, in order to obtain a higher quality acoustic profile.

In FIG. 4C, a more complex implementation is illustrated, in which acoustic responses are also used to improve the accuracy of the usage profile itself (before associating fill levels with acoustic responses). In FIG. 4C, each of 9 acoustic responses a to m are plotted. In FIG. 4C, each acoustic response is associated with a provisional fill level (based on the current container model), with this fill level representing the plot. As can be seen, the provisional fill level decreases generally with respect to time from the time A to the time F, but not regularly and continuously. It will be appreciated that FIG. 4C is a simplification, and in practice many more acoustic responses would generally be captured. Acoustic response a is captured at the time A (when the container has just been filled). The fill level at this time is known with a high degree of certainty. Acoustic response b is captured some time later, and has not changed from response a. It can therefore be assumed that the container has not yet been used, and so a usage start time has not yet been reached. Acoustic response c is captured after this, and indicates a decrease in fill level (for the first time). The usage start time can be set at the time of capture of acoustic response c, or at the time of capture of acoustic response b (the last acoustic response captured before a reduction in fill level is detected), or part way between b and c.

The provisional fill level continues to decrease for acoustic responses d and e, but then the decrease is paused between acoustic responses f and g. As a result, the period between f and g may effectively be ignored when defining a linear (for example) decrease in fill level. This is based on an assumption that while the container model may need to be refined to improve the accuracy with which acoustic profiles can be mapped to absolute fill levels, the fact that a fill level has not changed may in some embodiments be considered to be known with a high degree of fidelity even if the absolute fill level cannot be trusted. However, it should be noted that acoustic profiles are not guaranteed to be identical for identical fill levels, due to factors such as background noise, and so alternative techniques may in some embodiments be required to be able to detect a period of non-use. The same principles of non-use detection apply for acoustic responses i and j. It can also be seen that a usage end time can be determined as the first acoustic response which matches an acoustic response obtained at time F just before refilling the container. Note that it may be possible to measure, at the time of refilling, an amount of gas (or other contents) added to the container, and thus inferring an amount of gas which remained prior to refilling. In this way, the fill level at the time of refilling, and thus at the usage end time, can be known with a high degree of certainty. The usage profile can thus be defined from the usage start time (for which the fill level is known with high certainty) to the usage end time (for which the fill level is known with high certainty) through the intervening period during which non-use periods can be discounted and during which a (constant or variable) gradual decrease in fill level can otherwise be assumed. This information provides high quality test data for use in the machine learning algorithm for training the container model.

As discussed in relation to FIG. 4C, the usage profile can be enhanced based on captured acoustic profiles, for example by assuming no usage during periods when a provisional fill level (or the acoustic profiles themselves) do not change. In addition, if the provisional fill level (mass of content) is shown to increase, the associated acoustic profiles (which may be the one showing an increase, or an earlier erroneous acoustic profile from which the increase was measured) may be discounted. However, due to the difficulties in reliably detecting periods of non-use of gas, in some embodiments the method instead relies on the averaging effect of large numbers of cylinders being used with differing usage profiles. Whilst any one usage profile is unlikely to be linear, the average of a large number of profiles is likely to be linear. Since training feedback only needs to be correct on average, this may still yield an accurate model.

In the above example, a speaker is used to generate an acoustic signal to agitate the container. In an alternative embodiment, the agitation of the container instead relies on background (ambient) noise or vibration. For measurements using ambient noise, the speaker 105 is not required (thus simplifying and reducing the cost of the transducer device). This works well where the ambient noise is predictable, constant and consistent, and in particular if the ambient noise is substantially the same as the ambient noise present at the time the container model was trained. To rely on ambient noise as the stimulus in a wider range of noisy environments, a second microphone could be used. This would enable a comparison of the frequency content, or PSD (Power Spectral Density), of the signal from a microphone attached to/facing towards the cylinder with another microphone positioned to primarily measure the ambient noise. The power spectral densities from the two microphones could then be processed in one of the following two (illustrative) ways:

(A) A comparison of relative amplitudes across the frequency spectrum would allow the acoustic frequency response of the cylinder to be determined. This response would then form the input to the machine learning model (during training) and to the container model (during measurement).

(B) Alternatively, it could be possible to provide both microphone PSDs independently to the machine learning and train it using a variety of ambient noise.

Option (A) may be inferior to option (B) when the ambient noise does not sufficiently cover the frequency range learnt by the model. Option (B) has the potential to cope with a much wider range of noise at the expense of a more lengthy training process.

Both of these approaches could not only be used for pure ambient noise, but also for a combination of driven stimulus and ambient noise, which would provide a very effective method of background noise handling.

With the present technique, any number of transducer devices may be triggered remotely provided the devices are appropriately connected to a data network. This could include technologies such as Wi-Fi, Bluetooth, 4/5G or Lo-Ra. Once triggered, as explained in detail above, the computing device 110 sends sound data to the speaker 105 to agitate the tank or cylinder 30. The microphone 107 picks up the acoustic profile of the frequency response of the container 30 to this sound and the computing device 110 sends the resulting acoustic data, via the communications device 120, to the Time to Frequency Domain Converter 130. From here, the data is converted for use by the model. A fill level measurement of the tank or cylinder is provided as the output.

It is possible to apply machine learning to the data in the time domain rather than the frequency domain.

The present technique provides a low-cost and effective solution in the form or a device and/or system that can non-invasively measure the fill level of cylinders and tanks to an acceptable accuracy. It will be appreciated that the components required (microphone, speaker, communications and processing circuitry) are all readily available at low cost, and much of the invention may be implemented at the server side using suitably calibrated algorithms.

Another benefit to this approach is the ability to obtain a result from a given tank or cylinder from a remote location. This enables a business to remotely monitor the fill levels of a large number of tanks or cylinders simultaneously and without any further assistance.

The container models could be initialised to form an initial working model by stimulating containers in an otherwise substantially silent environment—that is, with substantially no background noise. However, a container model generated by machine learning on a set of sample acoustic profiles generated in a silent environment may be less robust when used to determine the fill level of a container in a noisy environment. To improve the robustness of the container model, the training may be carried out in a noisy environment, or a variety of different noisy environments. Alternatively, the acoustic profiles could be captured in a low noise environment, but noise could be added by signal processing before being used to train the model. The resulting model can then be continuously revised using data captured “in the field”. Alternatively, the method can be used without initialisation, using only data in the field and usage profile assumptions.

A working solution could be further optimised by the use of location data, either directly determined by the cylinder-mounted device via methods such as GPS or Wi-Fi network recognition, or independently determined from logistics or customer data. A cylinder leaving a refilling plant will be full. The movement of a cylinder from a location considered to be a gas supplier location (e.g. filling plant, distribution centre, consumer outlet) to a location not considered to be a gas supplier location could be considered as the delivery of a full cylinder to a customer. This could be defined as a usage start time for the usage profile. Likewise, a cylinder could be considered to be no longer in use (usage end time for the usage profile) when it returns to a distribution centre or outlet, rather than waiting until the point where it is refilled. With this information, a simple linear approximation of usage from the point of filling to the point of refilling may be refined to more accurately reflect the actual start and end of usage.

Application knowledge combined with customer and logistics data may also be used to further refine the approximation of likely fill level. For example, the typical time of day when usage will occur for a given container or set of containers, for example use during business hours, may further inform the estimation of usage and therefore fill level. Furthermore, statistical correlation with factors such as weather, temperature, sporting events and so on may be used to improve estimates. Referring back to FIG. 4C, non-use periods may be identified in this way (e.g. particular hours of the day and/or days of the week). Over longer periods, different usage gradients (proportion of overall usage per unit time) may be applied to different portions of the overall duration of the usage profile. For example, if the gas in the container is used for heating, and lasts for several months, usage may be weighted so that during summer months the usage is less than in winter months. Local temperatures (for example in the vicinity of the container) may also be used—for example, greater usage may be assumed for cold days than for warm days. In other words, in some embodiments the usage rate may not be linear (constant gradient) between the usage start time and usage end time, but may vary over the duration of the usage profile as a function of certain variables. The variation may be at any level of temporal granularity, for example hours, days, weeks or months.

Further benefit may be obtained through exploitation of the fact that a wealth of data may be quickly obtained for the case where cylinders are full. As mentioned above, containers may be considered full until delivered to the end user. Cylinders may spend some time full of gas prior to being dispatched to a customer and subsequently used. If a model can distinguish a full cylinder from a non-full cylinder, then the customer usage approximation may be further refined, since the start point for usage will be more accurate (the first time the gas level is estimated to have dropped, as explained with reference to FIG. 4C above). In other words, if it can be determined early on that the cylinder is full and the previous measurement indicated that the cylinder is full then it can be assumed that the cylinder has not been used yet. Likewise, a large volume of data points may be gathered for the empty case (or the final fill level before refilling, as explained with reference to FIG. 4C above), allowing both start and end of usage to be determined and thus a more accurate approximation of usage can be obtained to train for the intermediate levels.

Determination of a level change versus no change may also be achieved either through training of a model, or through analysis/correlation of a series of frequency responses. This determination can also be used to improve the accuracy of the level approximation that is used to train the level determination model. In particular, by separately distinguishing “no change” cases between two or more temporally adjacent acoustic profiles from the same container, it is possible to “break” the assumption that the fill level is gradually decreasing for this period, and thus make the usage path more accurate, again as discussed above with reference to FIG. 4C.

Further fill level information could also be incorporated at the point of cylinder refill. Due to variations in cylinder tare weight, and the amount of gas provided in a full cylinder, information regarding the amount of gas used to fill a cylinder can be used to determine the amount of gas that was in the cylinder prior to being filled. This provides an accurate fill level to associate with the usage end time of the usage profile.

A method for determining the fill level of a cylinder requires a numerical output from an acoustic profile. This naturally lends itself to take advantages of both classification and regression machine learning methods. The number line (from full to empty) is split into distinct classifications. This classification method is implemented to benefit from pattern recognition of the acoustic profile. However, the regression method error function, given previously, is used on the classification output which is conveniently numerical in nature. It should be noted that unlike other classification applications, the classifications used in the present technique are numerically linked which makes this approach viable.

Current level determination by the model uses a multi-category outcome rather than continuous outcome approach and derives the fill level with a singular highest probability category outcome methodology. Multi category will be understood to be a multi-class classification model. So, if for example, 10 different categories are used from full to empty, for example full to 90%, 89% to 80% etc, the model can only decide between those categories. In contrast, a continuous outcome approach is referred to as a regression model whereby the model outputs any number between 100 (full) and 0 (empty). The present technique preferably uses a blend of these approaches, which has been found to perform better.

In training, any category error is independent of the magnitude of the error. A further enhancement to the model would include penalising the model based on the magnitude of the error. Penalising the model in this way may be achieved by determining the numerical difference between the categories; that is, adopting a categorical model to determine the outcome. This utilises the advantages of pattern recognition. To determine the error, a continuous outcome approach may be adopted between the categories which hence enables use of the same error function. The singular outcome could also be enhanced to provide a probability outcome distribution to smooth singular errors. In a simple implementation, the model may choose the category with the highest probability and ignore all other categories. As an example, if the raw model output indicates: “40% probability of 20% full, 30% probability of 70% full, 30% probability of 60% full”, then the simple implementation would choose 20% full while a probability distribution approach would suggest the 20% full suggestion may be an error. With that information, a more informed decision on the fill level to be output can be made.

The model could also incorporate a heavy penalty for a rising fill level to further avoid determination errors. For example, the existing error function could be multiplied by:

1+e^{(Y}^{₀}^{-d)}

This causes the error function to increase in value dramatically when the estimate is above the previously measured value. Note that an apparent increase in fill level could be due to either the present data point or the previous data point (or both) being incorrect.

For each acoustic profile, a signal-to-noise ratio may be determined. A signal-to-noise ratio may be poor in cases where there was a high level of background noise at the time the acoustic response was captured. Acoustic profiles with a low signal-to-noise ratio may be ignored (not entered as part of the training data), or may be weighted with a penalty in the machine learning algorithm. Alternatively, the signal-to-noise ratio of an acoustic profile may represent a data point within the test data processed by the machine learning algorithm.

A multi-model approach could also be used to increase the robust nature of level determination. As the implementation of the various techniques described herein is applied and evaluated in real-world implementations, it is anticipated that the different approaches, such as training algorithms, will be implemented and refined over time. This process will yield multiple models, be that simply the current live model and a new model under evaluation, or potentially multiple models that perform better under different conditions. Voting on the outcome of these various models would reduce the impact of individual model bias. In this case, each model would have an associated error, and in a simple voting strategy the model with the lowest error may be selected. In another implementation, the outputs of different models may be combined or weighted to obtain a result. If, over time, a given model is seen to perform poorly relative to other models (and hopefully consequently lose vs. other models), it can be manually retired from the system.

Additional data points could be applied for model training, in addition to the response data and signal to noise indicators. Each additional characteristic for which additional data points are provided may be considered as additional column of data added to the data table (that is, a new instance of x within equation 1 above). It will be appreciated that the machine learning approach does not itself “understand” the data, and seeks simply to minimise an error function between output data of a current model (iteration) and actual (test) data. While the machine learning algorithm/model is primarily intended to minimise errors using amplitudes of frequencies, any numerical or categorical value for any characteristic (such as those indicated above and below) can be handled in the same way. The use of additional data points relating to the cylinder itself would be beneficial. A unique ID data point for each individual cylinder might be considered, but in practice would require significant data for each cylinder to be collected and may be too excessive in practice. An alternative methodology would be to determine ‘features’ of individual cylinders. Examples of cylinder features could include tare weight, material, material thickness, overall dimensions, age, and valve type. Features could be categorical, such as material, or numerical, such as tare weight. Furthermore, the measured response of the cylinder when full can also form an additional feature input to the model, either directly, or indirectly. Thus the initial response of a cylinder when filled may be used to compensate for any unique characteristics of that cylinder. This compensation may alternatively be applied directly to the measured frequency responses, rather than being passed to the model. For categorical data, each different possible category value may be mapped to a boolean input, which can be handled easily by the model in an analogous way to frequency response data values.

Differing environments of operation will contribute to variations in the acoustic data output. A further enhancement would be to include (in relation to each acoustic response) data features that relate to the physical location, whether indoors/outdoors, ambient temperature, cylinder temperature (at one or more positions on the exterior of the cylinder), humidity and atmospheric pressure. The cylinder temperature in particular is relevant due to the cooling effect of the LPG liquid turning into a gas during cylinder use. Some of this information can be obtained from weather data and/or customer/logistics data, while others will require additional sensors located within or in close proximity to the device. The additional data features may be provided as additional parameters for the algorithm to minimise errors on, in an analogous manner to the frequencies. In other words, any additional ‘features’ that are applied to the model may simply be an additional column of data added to the data table (a new instance of x within equation 1 above).

It will be appreciated that, in the case of a gas canister or the like, an acoustic profile captured may vary also in dependence on whether the container is currently in use (that is, gas is being released from the container) or not in use. Generally, the in use and not in use cases may be ignored, and handled by the robustness of the machine learning, by way of training using test data for both cylinders which are both in use and not in use at the time acoustic profiles are captured. Alternatively, when detecting fill level, an in-use flag may be generated at the transducer device, for example based on temperature information (that is, a detected temperature gradient or a difference between container temperature and ambient temperature as described elsewhere). The in-use flag and acoustic profile can then be used to identify the fill level. This could be achieved by using the in use flag as a parameter (having two possible values) within the machine learning algorithm, or alternatively (but less desirably) separate container models may be trained to deal with in use vs not in use cases, with the resulting models being selected between (both for training and fill level estimation purposes) using the in use flag.

It is also possible to train the container model to determine whether a cylinder is in use based on a captured acoustic profile (in addition to identifying the fill level), although it would be necessary to capture the distinction of “in use” versus “not in use” as another item of data during training to allow the machine learning algorithm to learn to recognise one from the other. In this case, in a similar way that it is possible to infer a likely fill level, it is also possible to infer a likely “in use” flag based on whether the fill level/response is changing or not. Again, such training data would not be accurate, but would be correct on average, which is sufficient. In an alternative implementation, a separate model may be formed for this output and, being simpler than level determination and requiring substantially less test data, may be reasonably trained for under controlled conditions. One benefit of determining automatically whether a container is in use or not in use is to determine when to take a next fill level measurement so that measurements are (for example) taken more frequently when the container is being used than when it is not being used. For example, if the cylinder is in use at a time when a measurement of fill level is taken, then a next measurement may be taken sooner (for example in one hour) than if the cylinder is not in use (for example in 12 hours).

One consideration for obtaining a robust container model that relates an acoustic response to a fill level for a single cylinder type, rather than merely for a single cylinder, is the amount of data that would need to be collected to provide the model with a sufficiently high signal to noise ratio with regard to the relationship between acoustic response and associated fill level. A greater volume of data (acoustic responses to different fill levels) enables non-fill level effects to the acoustic response such as slightly differing cylinders, temperature dependence and environmental noise to be filtered out. In collecting such large amounts of data, it is desirable to obtain acoustic responses to be associated with each of a range of determined fill levels. One alternative approach to the present technique would be to collect reference level measurements for a large number of cylinders at a range of fill levels using an independent measurement apparatus, such as a set of scales or a pressure gauge. Each reference level measurement may be associated with an acoustic response obtained at the same time. However, the volume of data required makes the implementation of a reference measurement impractical. It is for this reason, the present technique does not require a reference level.

Embodiments of the present technique also have the potential to more intelligently control power management to balance frequency of measurement against longevity of power source in the wider application, logistics and commercial context.

The usage profile with respect to time is a representation of the probable fill level of the container as a function of (elapsed) time. The usage profile may be considered as (or represented by) a graph having time (or a derivative of time, or some other time dependent variable) on one axis (for example the x-axis), and a likely fill level on the other axis (for example the y-axis). The “units” of the likely fill level axis may for example be in percentile units (0% to 100%), as an integer (or non-integer) value ranging from 0 to a maximum value, or labelled values such as empty, ¼, ½, ¾, full). The units of the time axis may be measured in seconds, minutes, hours, days, weeks or months (for example), but if/once normalised (discussed elsewhere) may simply be measured from “usage start” to “usage end”, that is as a unitless quantity. The usage profile with respect to time may be inferred, or derived, from one or more pieces of (time based) usage data, such as a start of usage of the container and an end of usage (or time of refill) of the container. The usage profile can be expected to take the form of a fill level which decreases with respect to time at a rate which is derived or inferred from the usage data. It will be understood that, while the usage profile defines a relationship between (likely) fill level and time for a plurality of (discrete) times, or a continuum of times, the fill level may only be definitively known at (for example) a single time (generally the start of use), with the fill level at all other times merely being a probable fill level inferred from usage data.

When the obtained acoustic responses are associated with the relevant part of the usage profile (based on time information of the acoustic response), the resulting relationship between acoustic response and fill level is therefore not known, but merely probable. The time of capture (detection) of each acoustic response may be recorded with a time stamp, with the time stamp being associated with (and stored with/transmitted with) the acoustic profile. In this case, acoustic responses for a container can be associated with the usage profile for that container by inferring, for each time stamped acoustic response and using the usage data/profile, a likely fill level for the container at the time indicated by the time stamp.

It will be understood that the usage profile may be generated, from the usage data and in its entirety, any time in advance of the step of associating acoustic responses with it, or alternatively the usage profile may be generated on the fly (and potentially only in part) at the time of the step of associating acoustic responses with it (for example by determining the likely fill level at the time corresponding to the time stamp from usage data, without determining the fill level for other times). In the latter case the usage profile may be considered to be gradually built as it is associated with plural acoustic responses at different times.

Explained differently, the present method may be considered to comprise steps of obtaining usage data for a canister, obtaining acoustic profiles in relation to the canister, each acoustic profile having an associated time stamp, for each time stamp, inferring a likely fill level for the canister based on the usage data, and associating the inferred likely fill level with the acoustic profile for that time stamp, to form the test data. If the usage profile is to be normalised (with respect to time) before association with acoustic responses, it will be appreciated that both the usage profile and the times of acquisition of the acoustic responses would both require (common) normalisation, in order that they can be properly associated with each other based on (normalised) time.

1. A method of configuring a container model, the container model defining a relationship, for a particular type of container and/or contents, between characteristics of an acoustic response and an associated fill level, the method comprising the steps of:
detecting an acoustic response of a plurality of containers to an acoustic stimulus at a plurality of different times;
for each container, obtaining a usage profile with respect to time, and associating the acoustic responses for that container with the usage profile, to form a set of test data; and
computing a relationship between characteristics of an acoustic response and an associated fill level using the test data to generate the container model.

2. A method according to claim 1, wherein the step of obtaining a usage profile comprises obtaining a usage start time for the container.

3. A method according to claim 2, wherein the usage start time is inferred from one or more of location information and logistics information.

4. A method according to claim 2, wherein the usage start time is inferred from a change in measured acoustic response from an acoustic response obtained when the container is known to be full.

5. A method according to any preceding claim, wherein the usage profile for a particular container represents a likely fill level with respect to time, and the step of associating the acoustic responses with the usage profile for that container comprises determining a likely fill level for each acoustic response based on a time at which that acoustic response was obtained and the usage profile, and associating that acoustic response with the determined likely fill level for that acoustic response.

6. A method according to claim 2 and claim 5, comprising obtaining a usage end time and determining the likely fill level for each acoustic response using the usage start time and the usage end time.

7. A method according to claim 6, wherein the usage end time is inferred from location information.

8. A method according to claim 6, wherein the usage end time is inferred by determining a final fill level before refilling the container, and identifying from the obtained acoustic responses a time at which that fill level was reached.

9. A method according to any preceding claim, comprising recording the detected acoustic responses as time domain signals, and converting the time domain signals into frequency domain representations, wherein the characteristics of the acoustic response are frequency characteristics.

10. A method according to claim 9, wherein the relationship is computed by applying a weight and a bias to an amplitude of each frequency of the frequency characteristics of the test data, and varying the weight and/or bias to minimise an error function.

11. A method according to claim 10, wherein the error function represents differences between a fill level determined by the container model and estimated fill levels included in the test data.

12. A method according to any preceding claim, comprising a step of normalising the usage profile and the capture time of the acoustic responses of each container with respect to time to form the test data.

13. A method according to any preceding claim, wherein the computing step utilises a machine learning algorithm.

14. A method according to claim 5, comprising obtaining a usage end fill level for a container, wherein the step of determining the likely fill level for each acoustic response uses the usage end fill level.

15. A method according to claim 5, wherein the step of determining the likely fill level for each acoustic response comprises identifying when on a path from full towards empty the acoustic response was obtained, and identifying, based on an assumed shape of the path from full towards empty, a likely fill level at the time of measurement of the acoustic response.

16. A method according to claim 15, wherein the assumed path from full towards empty is linear.

17. A method according to claim 15, wherein the assumed path from full towards empty is dependent on one or more parameters.

18. A method according to claim 17, wherein the parameters include one or more of time of day, day of the week, weather, temperature and local events.

19. A method according to claim 2, where the usage start time is determined from either a time of delivery of the container to a customer, or a time of fill or refill of the container.

20. A method according to claim 2, where the usage end time is determined from either a time of return of the container to the supplier or a time of refill of the container.

21. A method according to any preceding claim, comprising measuring a temperature at a container at the time of detecting the acoustic response, associating the measured temperature with the acoustic response in the test data, and wherein the step of computing computes the relationship between characteristics of the acoustic response, temperature, and associated fill level using the test data.

22. A method according to claim 21, wherein the step of measuring temperature at a container comprises measuring a temperature of at least part of the exterior surface of the container and measuring a temperature of the environment around the container, and determining that the container is currently in use in the case that the temperature of the surface of the container is different to the ambient temperature by more than a threshold amount.

23. A method according to claim 22, wherein the step of measuring temperature at a container comprises measuring a temperature at a plurality of positions on the exterior surface of the container, and determining that the container is currently in use in the case that a temperature gradient greater than a threshold gradient is measured across the plurality of positions.

24. A method according to any preceding claim, comprising determining whether a container is in use at the time of detecting the acoustic response for that container, associating the in use or not in use state with the acoustic response in the test data, and wherein the step of computing computes the relationship between characteristics of the acoustic response, the in use or not in use state, and associated fill level using the test data.

25. A method according to claim 24 as appendant on claim 22 or claim 23, wherein the in use or not in use state for a container is determined based on the temperature measurements.

26. A method of configuring a container model, the container model defining a relationship, for a particular type of container and/or contents, between characteristics of an acoustic response and an associated fill level, the method comprising:
detecting an acoustic response of a plurality of containers to an acoustic stimulus each at a plurality of different times; and
computing a relationship between characteristics of an acoustic response and an associated fill level for a particular type of container and/or contents using the detected acoustic responses and without using a reference level measurement.

27. A method of determining a fill level of a container, comprising the steps of:
detecting an acoustic response of the container to an acoustic stimulus;
generating an acoustic profile from the detected acoustic response; and
inputting the acoustic profile to a container model to determine a fill level of the container, the container model defining a relationship, for a particular type of container and/or contents, between characteristics of an acoustic response and an associated fill level; and
using the detected acoustic responses in a method of configuring the container model according to any preceding claim.

28. A system for configuring a container model, the container model defining a relationship, for a particular type of container and/or contents, between characteristics of an acoustic response and an associated fill level, the system comprising:
a plurality of acoustic transducer devices, each operable to detect an acoustic response of a respective one of a plurality of containers to an acoustic stimulus at a plurality of different times;
a configurator, operable to obtain a usage profile with respect to time for each container, and to associate the acoustic responses for each container with the usage profile for that container, to form a set of test data; wherein
the configurator is operable to compute a relationship between characteristics of an acoustic response and an associated fill level using the test data to generate the container model.

29. A system for configuring a container model, the container model defining a relationship, for a particular type of container and/or contents, between characteristics of an acoustic response and an associated fill level, the system comprising:
a plurality of acoustic transducer devices, each operable to detect an acoustic response of a respective one of a plurality of containers to an acoustic stimulus each at a plurality of different times; and
a configurator, operable to compute a relationship between characteristics of an acoustic response and an associated fill level for a particular type of container and/or contents using the detected acoustic responses and without using a reference level measurement.

30. A system for determining a fill level of a container, comprising:
a plurality of acoustic transducer devices, each operable to detect an acoustic response of a respective container to an acoustic stimulus, and operable to generate an acoustic profile from the detected acoustic response; and
a fill level determiner for inputting the acoustic profile to a container model to determine a fill level of the container, the container model defining a relationship, for a particular type of container and/or contents, between characteristics of an acoustic response and an associated fill level; and
a model configurator for using the detected acoustic responses in a method of configuring the container model.
